(19) United States
(12) Patent Application Publication
(10) Pub. No.: US 2010/0077382 A1
(43) Pub. Date: Mar. 25, 2010

(54) COMPUTER-READABLE RECORDING MEDIUM STRING A BUG DETECTION SUPPORT PROGRAM, SIMILAR STRUCTURE IDENTIFICATION INFORMATION LIST OUTPUT PROGRAM, BUG DETECTION SUPPORT APPARATUS, AND BUG DETECTION SUPPORT METHOD

(75) Inventor: Kouji Sasaki, Yokohama (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/543,975

(22) Filed: Aug. 19, 2009

(30) Foreign Application Priority Data
Sep. 24, 2008 (JP) 2008-244848

(51) Int. Cl. G06F 9/44

(52) U.S. Cl. 717/124

(57) ABSTRACT

A bug detection support program includes: a structure identification information list output step of cross-referencing a source code and a plurality of items of detection condition information which is possibly a bug; a similarity calculation step of, in the event of receiving from the user a selection, calculating a similarity between structures corresponding to each item of structure identification information in the structure identification information list and a structure corresponding to the selected structure identification information; a structure identification information specification step of specifying items of structure identification information, from among the items of structure identification information in the structure identification information list, of which the similarity calculated by the similarity calculation step is of a pre-set predetermined threshold value or greater; and a similar structure identification information list output step of generating a similar structure identification information list, and outputting the generated similar structure identification information list.

### CROSS-REFERENCE TO RELATED APPLICATIONS

This application is based upon and claims the benefit of priority of the prior Japanese Patent Application No. 2008-244848, filed on Sep. 24, 2008, the entire contents of which are incorporated herein by reference.

### FIELD

The present invention relates to a bug detection support program, a similar structure identification information list output program, a bug detection support apparatus, and a bug detection support method which detect a structure which is possibly a bug from among a plurality of structures configuring a source code.

### BACKGROUND

In software development, an operation is carried out by which a bug in a source code compiled by a software developer is removed. There is a tool which, in order to reduce time and effort of the software developer needed for the bug removing operation, detects a structure which is possibly a bug from among a plurality of structures configuring a source code (for example, refer to JP-A-2005-228241). Hereafter, a simple description will be given of a bug detection support apparatus to which the tool is applied.

The bug detection support apparatus stores in advance a plurality of items of detection condition information in a storage unit. Herein, the detection condition information, being information indicating detection conditions for detecting a structure which is possibly a bug, is, for example, detection condition information “With conditional expression “if”, assignment operator “=” is used”. Then, the bug detection support apparatus, on receiving an input of a source code and a detection request from the software developer, cross-references the source code with each item of detection condition information. Continuing, the bug detection support apparatus detects a structure (for example, a structure “if (b=0)” or the like), from among the structures configuring the source code, which satisfies any item of detection condition information among the items of detection condition information.

Next, the bug detection support apparatus generates a structure identification information list in which are correlated and listed an item of structure identification information (for example, a structure line number) uniquely given to the detected structure, and the item of detection condition information satisfied by the detected structure. Then, the bug detection support apparatus outputs a display of the generated structure identification information list for the software developer.

The software developer, referring to the structure identification information list, visually confirms, one by one, whether or not the structure in the source code corresponding to each item of structure identification information in the structure identification information list is a bug. For example, the software developer confirms whether the assignment operator “=” is being used in a structure in which an equivalence operator “==” should be used. Then, in the event of determining that the structure is a bug, the software developer removes the bug.

However, with the heretofore known bug detection support apparatus, there is a problem in that unnecessary time and effort may be imposed on the software developer who carries out the operation of confirming whether or not the structure is a bug. That is, the heretofore known bug detection support apparatus merely lists and outputs structure identification information on structures which are possibly bugs. For this reason, the software developer has to confirm the source codes one by one for all the structures corresponding to the listed structure identification information, and confirm whether or not they are bugs. Consequently, with the heretofore known bug detection support apparatus, there is a problem in that the unnecessary time and effort of also confirming the source code for structures which are not bugs is imposed on the software developer.

### BRIEF DESCRIPTION OF DRAWINGS

FIG. 1 illustrates an outline of a bug detection support apparatus according to an embodiment 1.

FIG. 2 illustrates a configuration of the bug detection support apparatus.

FIG. 3 is one example of information stored in a source code storage unit.

FIG. 4 is one example of information stored in an analysis data storage unit.

FIG. 5 is one example of a structure identification information list.

FIG. 6 is one example of a selected structure identification information list.

FIG. 7 is one example of a similar structure identification information list.

FIG. 8 is a flowchart illustrating a flow of a process of the bug detection support apparatus.

FIG. 9 illustrates a configuration of a bug detection support apparatus according to an embodiment 2.

FIG. 10 is one example of information stored in a calculation definition information storage unit.

FIG. 11 is a diagram for illustrating a process of a similarity calculation unit.

FIG. 12 is a diagram for illustrating a process of the similarity calculation unit.

FIG. 13 is one example of a similar structure identification information list.

FIG. 14 is a flowchart illustrating a flow of a process of the bug detection support apparatus according to the embodiment 2.

FIG. 15 is an example of a history.

FIG. 16 is a flowchart illustrating a flow of a calculation definition information setting process.

FIG. 17 is one example of a dialog for setting a concordance rate and points after a conversion.

FIG. 18 is a diagram for illustrating a concordance rate calculation method.

FIG. 19 illustrates a computer which executes bug detection support programs.

### SUMMARY

According to an aspect of the embodiment, a recording medium on which is recorded a bug detection support program includes: a structure identification information list output step of cross-referencing a source code configured of a plurality of structures, and a plurality of items of detection condition information indicating detection conditions for detecting a structure which is possibly a bug, detecting structures which are possibly a bug, and outputting a structure identification information list, generated listing structure identification information uniquely given to the detected structures; a similarity calculation step of, in the event of receiving from the user a selection of any item of structure identification information in the structure identification information list, calculating a similarity between structures corresponding to each item of structure identification information in the structure identification information list and a structure corresponding to the selected structure identification information; a structure identification information specification step of specifying items of structure identification information, from among the items of structure identification information in the structure identification information list, of which the similarity calculated by the similarity calculation step is of a pre-set predetermined threshold value or greater; and a similar structure identification information list output step of generating a similar structure identification information list, in which are listed the items of structure identification information specified by the structure identification information specification step, and outputting the generated similar structure identification information list, correlated to the structure identification information selected by the user.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### DESCRIPTION OF EMBODIMENTS

Hereafter, a detailed description will be given, referring to the drawings, of embodiments of a bug detection support program, a similar structure identification information list output program, a bug detection support apparatus, and a bug detection support method according to the invention. Hereafter, a description will be given of, as an embodiment, a bug detection support apparatus to which the invention is applied.

### Embodiment 1

In a following embodiment 1, an outline of a bug detection support apparatus according to the embodiment 1, a configuration of the bug detection support apparatus, and a flow of a process of the bug detection support apparatus will be described in order, and lastly, advantages of the embodiment 1 will be described.

### Outline of Bug Detection Support Apparatus According to Embodiment 1

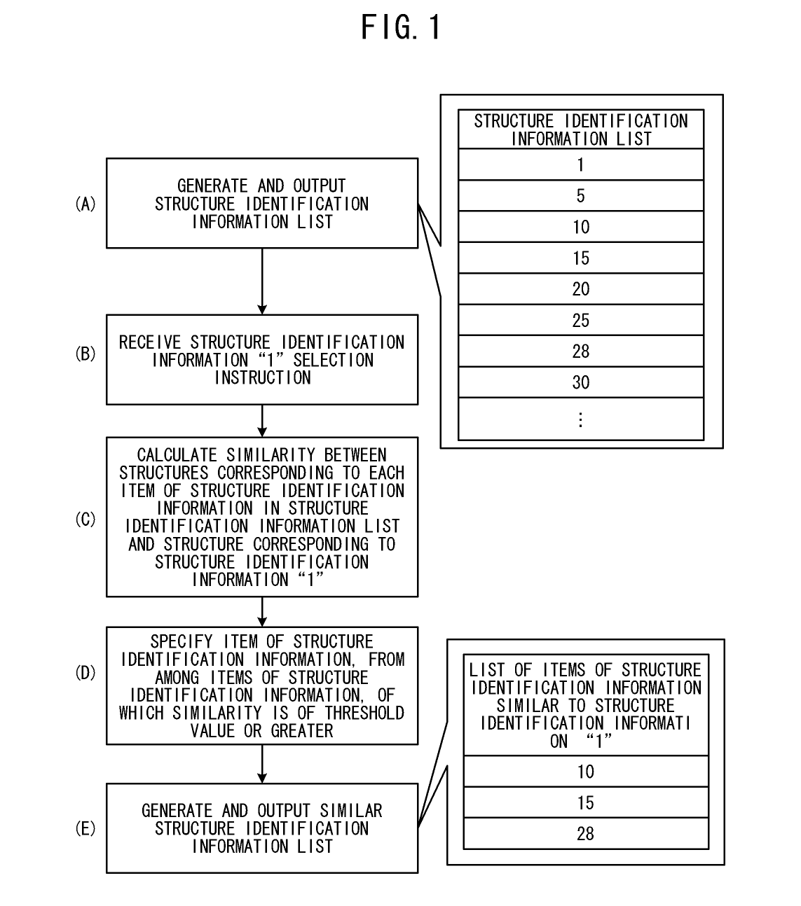

Firstly, a description will be given of the bug detection support apparatus according to the embodiment 1, using FIG. 1. FIG. 1 is a diagram for illustrating the outline of the bug detection support apparatus according to the embodiment 1.

The bug detection support apparatus according to the embodiment 1, its outline being that it outputs a structure identification information list, in which is listed structure identification information on a structure which is possibly a bug, to a software developer, in particular, curtails an occurrence of the unnecessary trouble of confirming a source code for a structure which is not a bug, and reduces time and effort of the software developer needed for an operation of confirming whether or not the structure is a bug.

That is, the bug detection support apparatus, on receiving a request from the software developer to detect a structure which is possibly a bug, cross-references a source code configured of a plurality of structures, and a plurality of items of detection condition information indicating detection conditions for detecting a structure which is possibly a bug, thus detecting structures which are possibly a bug. Continuing, the bug detection support apparatus, as shown in A of FIG. 1, outputs a structure identification information list, generated listing structure identification information uniquely given to the detected structures, for the software developer.

The software developer, referring to the structure identification information list, confirms whether or not a structure in a source code corresponding to a predetermined item of structure identification information, optionally selected from the structure identification information list, is a bug. Continuing, the software developer inputs into the bug detection support apparatus an instruction to select the item of structure identification information which he or she has confirmed to be a bug or otherwise.

The bug detection support apparatus, on receiving the structure identification information selection instruction from the software developer, as shown in B of FIG. 1, calculates a similarity between structures corresponding to each item of structure identification information in the structure identification information list and a structure corresponding to the structure identification information selected by the software developer, as shown in C of FIG. 1. Continuing, the bug detection support apparatus specifies items of structure identification information, from among the items of structure identification information in the structure identification information list, of which the calculated similarity is of a pre-set predetermined threshold value or greater, as shown in D of FIG. 1. Then, as shown in E of FIG. 1, the bug detection support apparatus generates a similar structure identification information list, in which are listed the specified items of structure identification information, and outputs the generated similar structure identification information list, correlated to the structure identification information selected by the software developer, for the software developer.

By this means, the bug detection support apparatus according to the embodiment 1 can curtail an occurrence of the unnecessary trouble of confirming a source code for a structure which is not a bug, and reduce the time and effort of the software developer needed for the operation of confirming whether or not the structure is a bug. For example, the bug detection support apparatus according to the embodiment 1, in the event of receiving from the software developer a selection of an item of structure identification information on a structure in which a bug has been detected, outputs a similar structure identification information list, in which are listed items of structure identification information on structures similar to the structure in which the bug has been detected. For this reason, the software developer, by confirming whether or not a structure is a bug only for the structures corresponding to the items of structure identification information listed in the similar structure identification information list, can efficiently detect a structure in which there is a bug. Consequently, the bug detection support apparatus according to the embodiment 1 can curtail an occurrence of the unnecessary trouble of confirming a source code for a structure which is not a bug, and reduce the time and effort of the software developer needed for the operation of confirming whether or not the structure is a bug.

Also, the bug detection support apparatus according to the embodiment 1, in the event of receiving from the software developer a selection of an item of structure identification information on a structure in which no bug has been detected, outputs a similar structure identification information list, in which are listed items of structure identification information on structures similar to the structure in which no bug has been detected. For this reason, the software developer, not needing to confirm whether or not a structure is a bug for the items of structure identification information listed in the similar structure identification information list, can eliminate the time and effort relating to the source code bug confirmation operation. Consequently, the bug detection support apparatus according to the embodiment 1 can curtail an occurrence of the unnecessary trouble of confirming a source code for a structure which is not a bug, and reduce the time and effort of the software developer needed for the operation of confirming whether or not the structure is a bug.

### Configuration of Bug Detection Support Apparatus

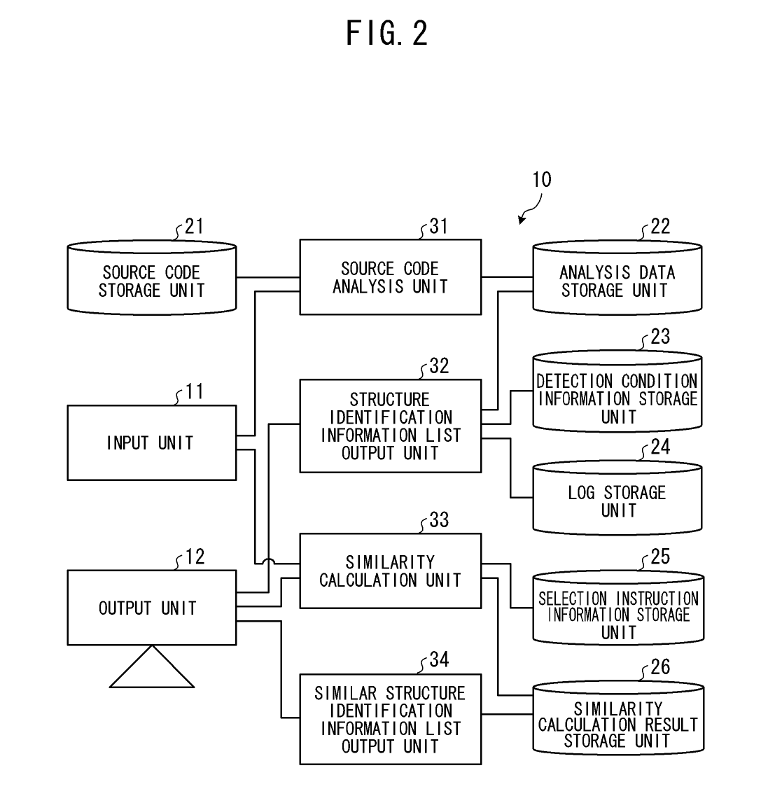

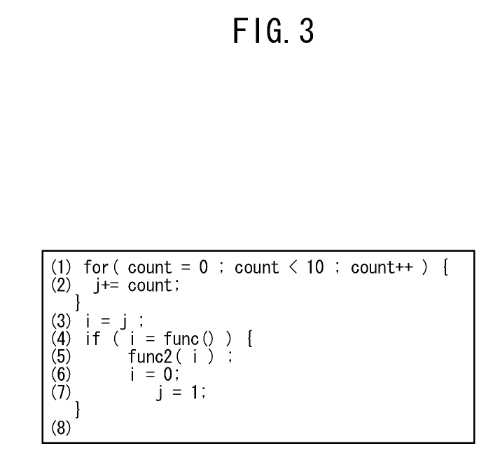

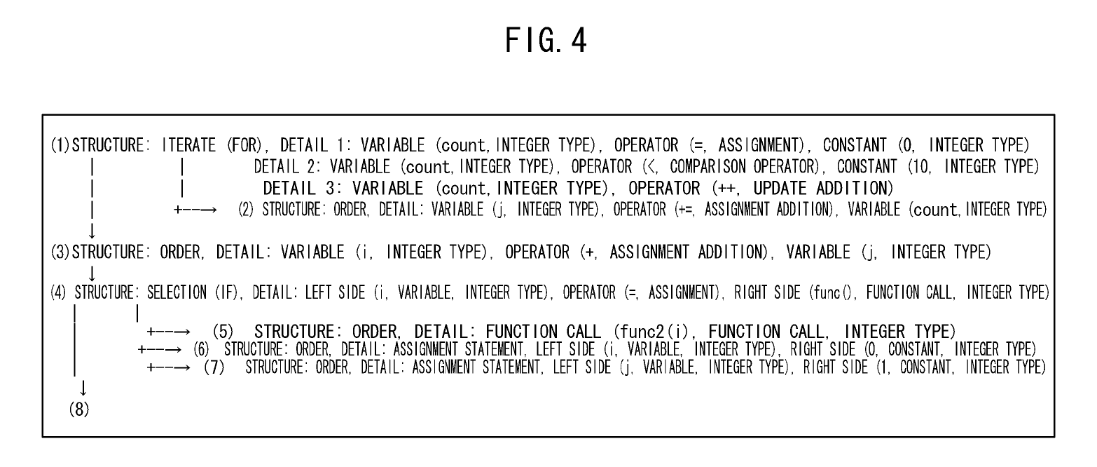

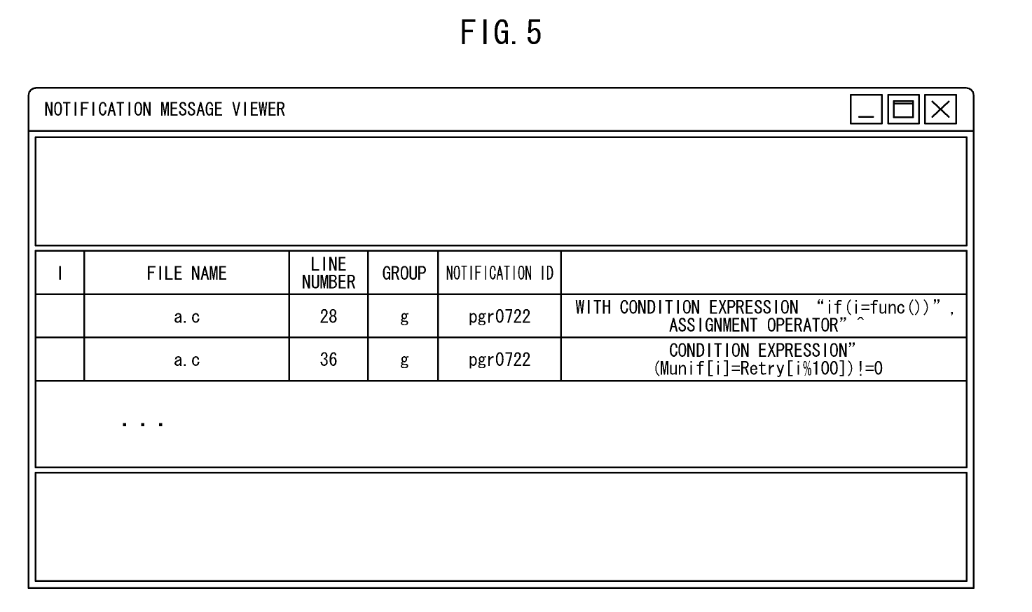

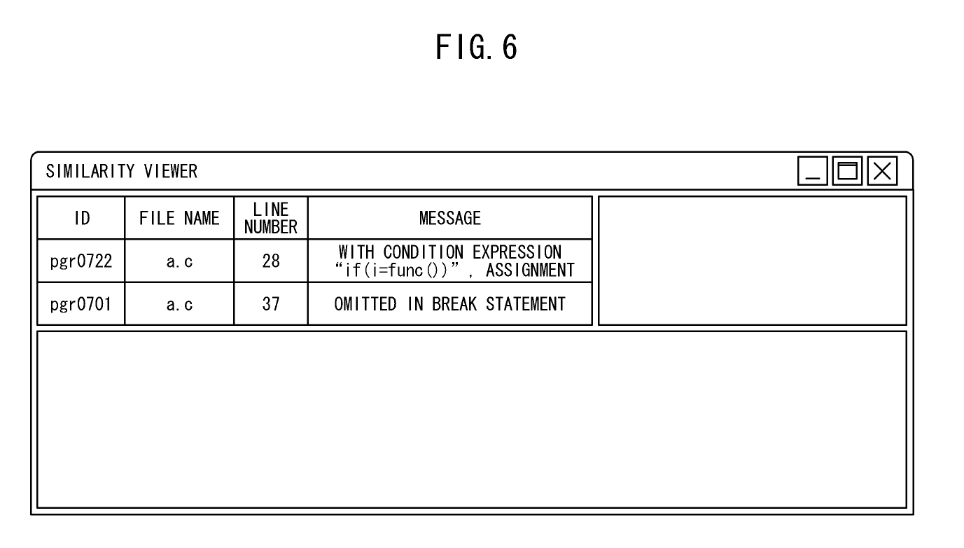

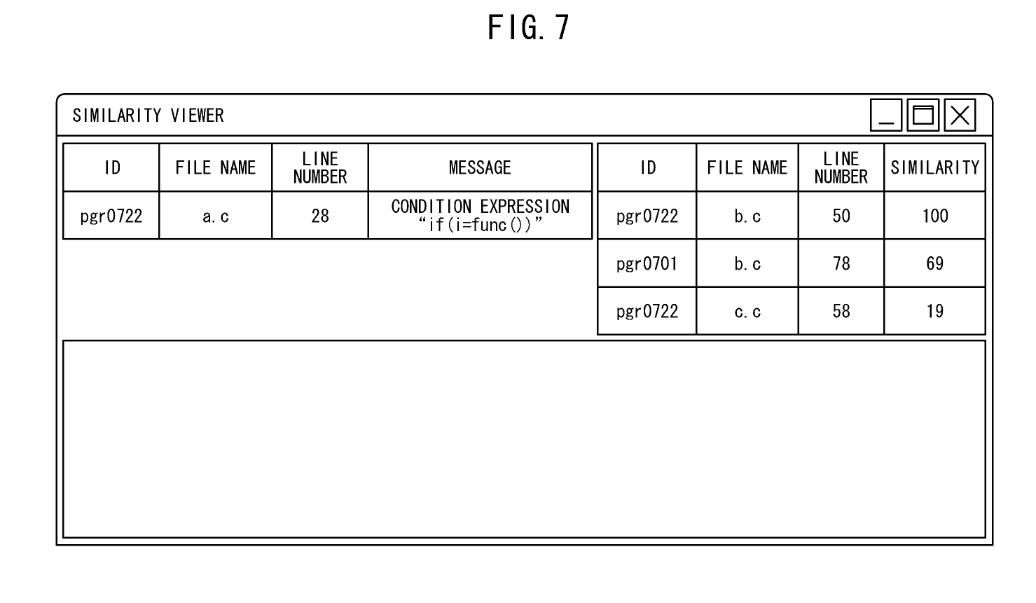

Next, using FIGS. 2 to 7, a description will be given of the configuration of the bug detection support apparatus illustrated in FIG. 1. FIG. 2 is a block diagram illustrating the configuration of the bug detection support apparatus. FIG. 3 is a diagram illustrating one example of information stored in a source code storage unit. FIG. 4 is a diagram illustrating one example of information stored in an analysis data storage unit. FIG. 5 is a diagram illustrating one example of a structure identification information list. FIG. 6 is a diagram illustrating one example of a selected structure identification information list. FIG. 7 is a diagram illustrating one example of a similar structure identification information list.

As shown in FIG. 2, the bug detection support apparatus 10 includes an input unit 11, an output unit 12, a source code storage unit 21, an analysis data storage unit 22, a detection condition information storage unit 23, a log storage unit 24, a selection instruction information storage unit 25, a similarity calculation result storage unit 26, a source code analysis unit 31, a structure identification information list output unit 32, a similarity calculation unit 33, and a similar structure identification information list output unit 34. The similar structure identification information list output unit 34 is also called the structure identification information specification unit.

Of these, the input unit 11 receives an input of various kinds of information. Specifically, the input unit 11 is configured equipped with a keyboard, a mouse, and the like.

The output unit 12 outputs various kinds of information. Specifically, the output unit 12, being configured equipped with a monitor or display, outputs a display of, for example, a structure identification information list in which are listed items of structure identification information.

The source code storage unit 21 stores a source code compiled by the software developer (refer to FIG. 3). Also, the analysis data storage unit 22 stores analysis data generated by a static analysis of the source code. Herein, the analysis data are data including, for example, a program model indicating a source code converted into a language construct, a data model indicating a data reference relationship and a function call relationship, and a flow model indicating a flow of a data process (refer to FIG. 4).

The detection condition information storage unit 23 stores a plurality of items of detection condition information indicating detection conditions for detecting a structure which is possibly a bug. Specifically, the detection condition information storage unit 23 correlates and stores detection condition identification information, for identifying detection condition information, with the detection condition information. For example, the detection condition information storage unit 23 correlates and stores detection condition identification information “pgr0722” with detection condition information “With conditional expression “if”, assignment operator “=” is used”.

The log storage unit 24 stores a log configured of structure identification information on a structure which is possibly a bug, correlated with detection condition identification information. Specifically, the log storage unit 24 correlates and stores, as a log, a source code file name, structure identification information (for example, a structure line number), a group name (for example, group name “a”) indicating a group to which the detection condition identification information belongs, the detection condition identification information, and a message (for example, “With conditional expression “if(i=func( ))” assignment operator “=” is used”).

The selection instruction information storage unit 25 correlates and stores structure identification information selected from the structure identification information list, detection condition identification information, a source code file name, and a message. Also, the similarity calculation result storage unit 26 correlates and stores the source code file name, the structure identification information, and a similarity indicating a degree of similarity between structures.

The source code analysis unit 31, by a static analysis of a source code, generates analysis data including a program model, a data model, and a flow model. Specifically, the source code analysis unit 31, on receiving a detection request from the software developer, retrieves a source code from the source code storage unit 21, carries out a static analysis of the source code, and generates analysis data. Continuing, the source code analysis unit 31 stores the generated analysis data in the analysis data storage unit 22.

The structure identification information list output unit 32 cross-references the source code and a plurality of items of detection condition information, detects structures which are possibly a bug, lists items of structure identification information uniquely given to the detected structures, and generates a structure identification information list. Then, the structure identification information list output unit 32 outputs the generated structure identification information list for the software developer. Specifically, the structure identification information list output unit 32, on the analysis data being stored in the analysis data storage unit 22, as well as retrieving the analysis data from the analysis data storage unit 22, retrieves all the detection condition information from the detection condition information storage unit 23.

Continuing, the structure identification information list output unit 32 detects, from among the structures configuring the analysis data, a structure satisfying any of the items of detection condition information as a structure which is possibly a bug. Then, the structure identification information list output unit 32, on detecting the structure which is possibly a bug, generates a log in which are correlated structure identification information uniquely given to the detected structure, detection condition identification information of the detection condition information which the structure satisfies, and the like, and stores the generated log in the log storage unit 24.

Subsequently, the structure identification information list output unit 32, after detecting, from among the analysis data, all structures which are possibly a bug, retrieves all logs stored in the log storage unit 24, and generates a structure identification information list in which are listed the items of structure identification information. Then, the structure identification information list output unit 32 outputs a display of the generated structure identification information list for the software developer, via the output unit 12. For example, the structure identification information list output unit 32 outputs the structure identification information list in a notification message viewer, as shown in FIG. 5.

The similarity calculation unit 33, in the event of receiving from the software developer a selection of one of the items of structure identification information from the structure identification information list, calculates the similarity between structures corresponding to each item of structure identification information in the structure identification information list and a structure corresponding to the structure identification information selected by the software developer.

Specifically, the similarity calculation unit 33, on receiving from the software developer, via the input unit, a selection of one of the items of structure identification information from the structure identification information list, stores the structure identification information selected by the software developer, the detection condition identification information, and the like, in the selection instruction information storage unit 25. Continuing, the similarity calculation unit 33 generates a selected structure identification information list, in which are listed the structure identification information selected by the software developer, the detection condition identification information, and the like, and outputs a display of the generated selected structure identification information list for the software developer, via the output unit 12. For example, the similarity calculation unit 33 outputs the selected structure identification information list in a similarity viewer, as shown in FIG. 6.

Then, the similarity calculation unit 33, on receiving from the software developer, via the input unit, a selection of one of the items of structure identification information from the selected structure identification information list, retrieves the detection condition identification information correlated to the structure identification information selected by the software developer from the selection instruction information storage unit 25. Continuing, the similarity calculation unit 33 retrieves, from among all the logs stored in the log storage unit 24, logs including detection condition identification information identical to the retrieved detection condition identification information, and acquires the structure identification information included in each retrieved log.

Next, the similarity calculation unit 33, as well as extracting each structure which is to be a subject for comparison from among the analysis data stored in the analysis data storage unit 22, based on the acquired items of structure identification information, extracts a structure which is to be a basis for comparison, based on the structure identification information selected by the software developer. Continuing, the similarity calculation unit 33 individually compares each structure which is a subject for comparison with the structure which is the basis for comparison, and calculates a similarity indicating the degree of similarity between the structures. Then, the similarity calculation unit 33 correlates the structure identification information of the structure which is a subject for comparison, the calculated similarity, and the like, and stores them in the similarity calculation result storage unit 26.

The similar structure identification information list output unit 34 specifies items of structure identification information, from among the items of structure identification information in the structure identification information list, of which the similarity calculated by the similarity calculation unit 33 is of the pre-set predetermined threshold value or greater. Then, the similar structure identification information list output unit 34 generates a similar structure identification information list, in which are listed the specified items of structure identification information, and outputs the generated similar structure identification information list, correlated to the structure identification information selected by the software developer, for the software developer.

Specifically, the similar structure identification information list output unit 34 specifies the items of structure identification information, from among all the items of structure identification information stored in the similarity calculation result storage unit 26, which correspond to a similarity of the pre-set predetermined threshold value or greater. Then, the similar structure identification information list output unit 34 generates a similar structure identification information list, in which are listed the specified items of structure identification information, and outputs a display of the generated similar structure identification information list, correlated with the structure identification information selected by the software developer, for the software developer, via the output unit 12. For example, the similar structure identification information list output unit 34 outputs the similar structure identification information list in the similarity viewer, as shown in FIG. 7.

### Process of Bug Detection Support Apparatus

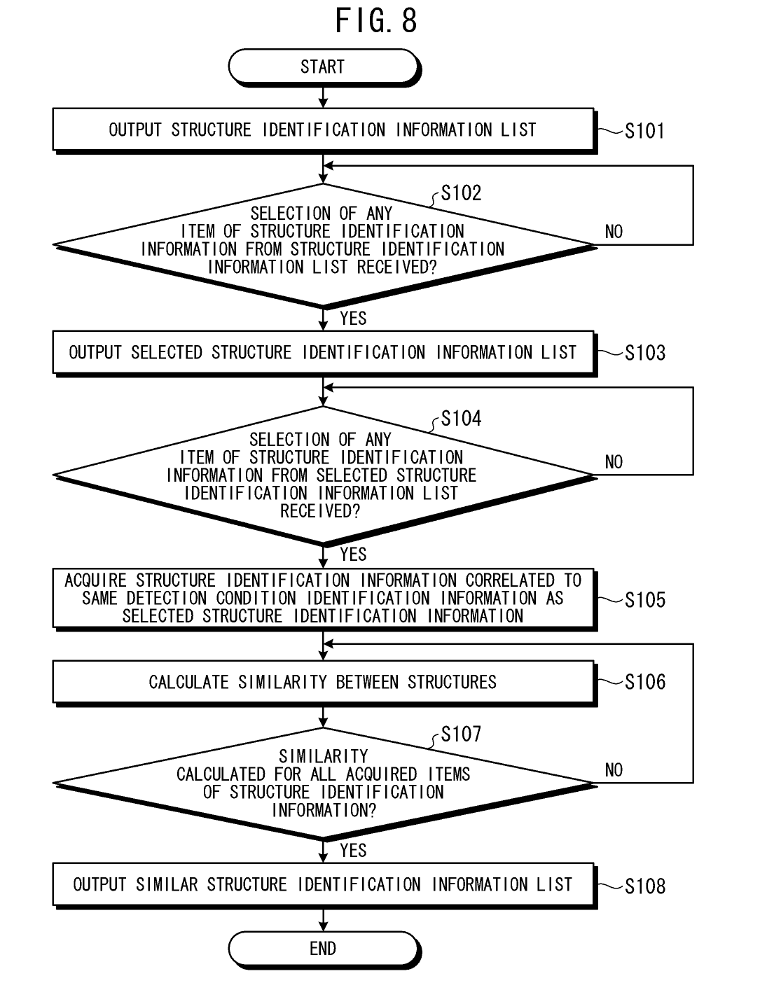

Next, a description will be given, using FIG. 8, of the process of the bug detection support apparatus 10. FIG. 8 is a flowchart illustrating the flow of the process of the bug detection support apparatus. As shown in FIG. 8, the structure identification information list output unit 32 detects a structure which is possibly a bug from a source code, and generates and outputs a structure identification information list (step S101).

Continuing, the similarity calculation unit 33, on receiving a selection of one of the items of structure identification information from the structure identification information list (step S102: Yes), generates and outputs a selected structure identification information list, in which is listed the structure identification information selected by the software developer (step S103). Then, the similarity calculation unit 33, on receiving a selection of one of the items of structure identification information from the selected structure identification information list (step S104: Yes), acquires items of structure identification information correlated to the same detection condition identification information as the structure identification information selected by the software developer (step S105).

Continuing, the similarity calculation unit 33 calculates the similarity between the structures corresponding to each acquired item of structure identification information and the structure corresponding to the structure identification information selected by the software developer (step S106). Subsequently, the similar structure identification information list output unit 34, on the similarity being calculated for all the acquired items of structure identification information (step S107: Yes), generates and outputs a similar structure identification information list, in which are listed the items of structure identification information of which the similarity is of the predetermined threshold value or greater (step S108), and finishes the process.

### Advantages of Embodiment 1

As heretofore described, according to the embodiment 1, it is possible to curtail an occurrence of the unnecessary trouble of confirming a source code for a structure which is not a bug, and reduce the time and effort of the software developer needed for the operation of confirming whether or not the structure is a bug. For example, the bug detection support apparatus 10, in the event of receiving from the software developer a selection of an item of structure identification information on a structure in which a bug has been detected, outputs a similar structure identification information list, in which are listed items of structure identification information on structures similar to the structure in which the bug has been detected. For this reason, the software developer, by confirming whether or not a structure is a bug by confirming the source code for the structures corresponding to the items of structure identification information listed in the similar structure identification information list, can efficiently detect a structure in which there is a bug. Consequently, the bug detection support apparatus 10 can curtail an occurrence of the unnecessary trouble of confirming a source code for a structure which is not a bug, and reduce the time and effort of the software developer needed for the operation of confirming whether or not the structure is a bug.

Also, the bug detection support apparatus 10, in the event of receiving from the software developer a selection of an item of structure identification information on a structure in which no bug has been detected, outputs a similar structure identification information list, in which are listed items of structure identification information on structures similar to the structure in which no bug has been detected. For this reason, the software developer, not needing to confirm whether or not a structure is a bug by confirming the source code for the items of structure identification information listed in the similar structure identification information list, can eliminate the time and effort relating to the source code bug confirmation operation. Consequently, the bug detection support apparatus 10 can curtail an occurrence of the unnecessary trouble of confirming a source code for a structure which is not a bug, and reduce the time and effort of the software developer needed for the operation of confirming whether or not the structure is a bug.

### Embodiment 2

It is acceptable that a method of calculating the similarity between structures is embodied in various differing forms. Therein, in an embodiment 2 below, a description will be given of a bug detection support apparatus 10 which calculates the similarity between structures using calculation definition information set by the software developer. Hereafter, a configuration of the bug detection support apparatus according to the embodiment 2, a flow of a process of the bug detection support apparatus, and advantages of the embodiment 2 will be described.

### Configuration of Bug Detection Support Apparatus

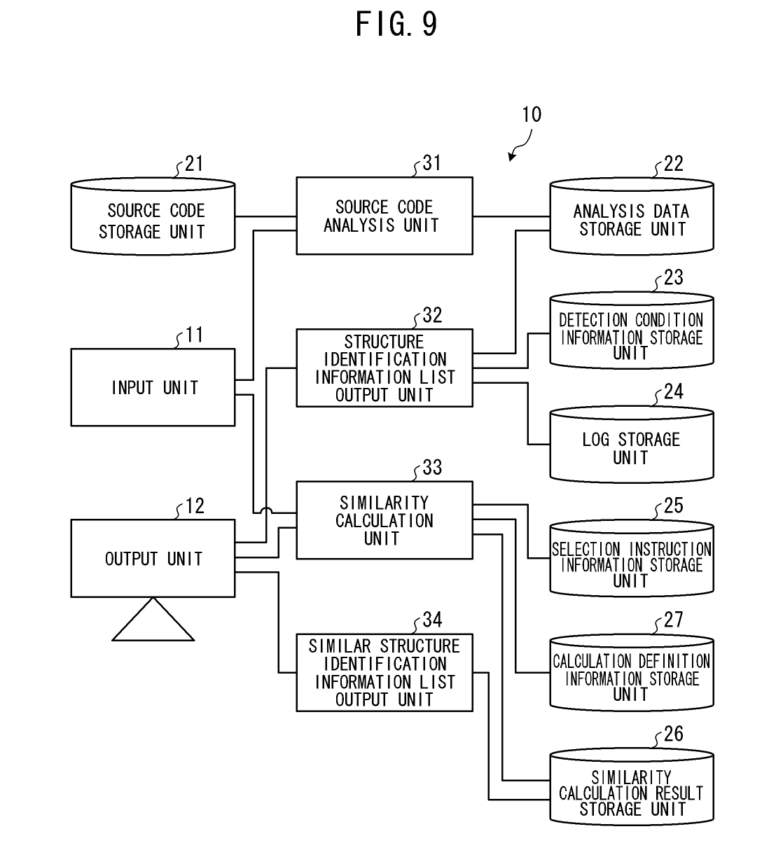

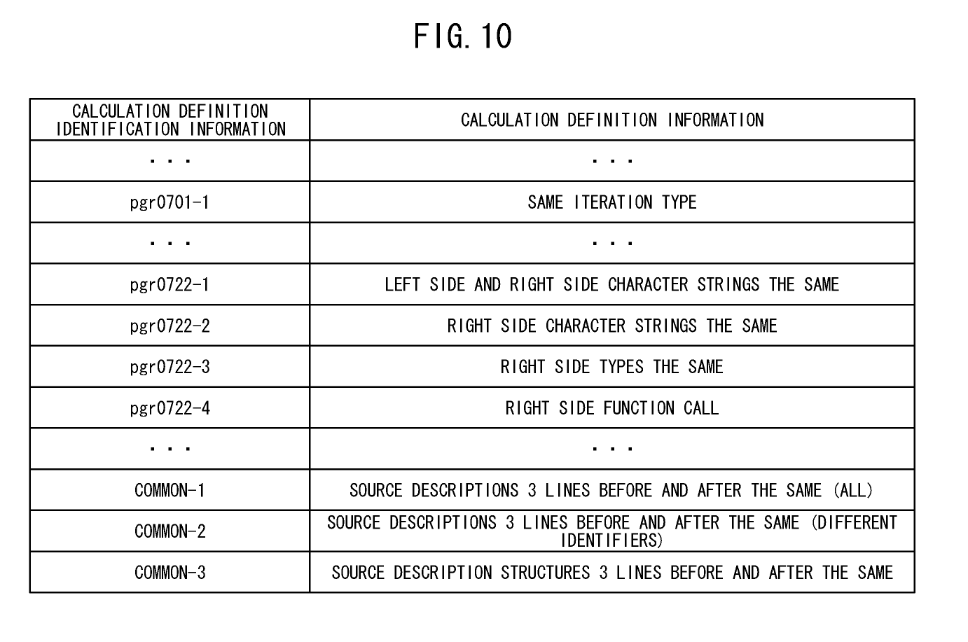

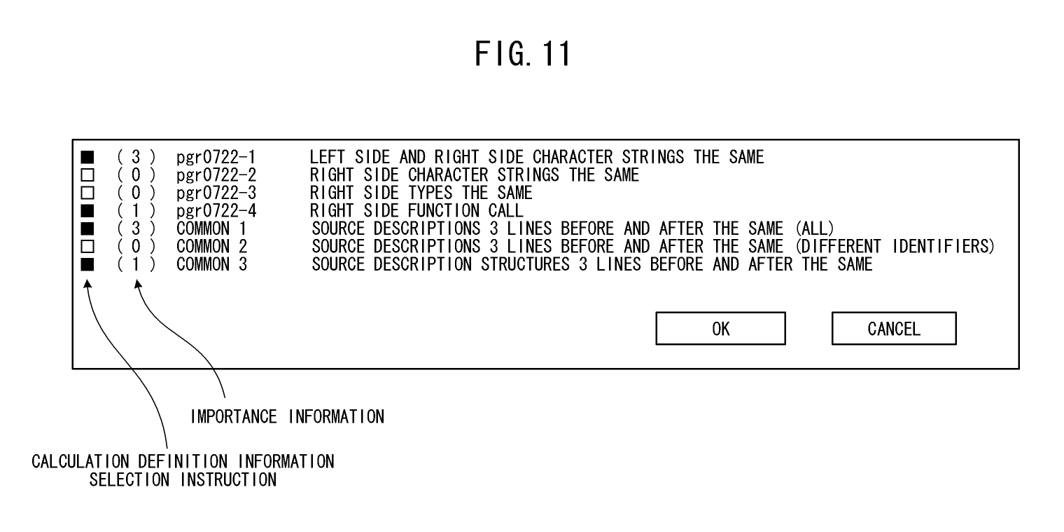

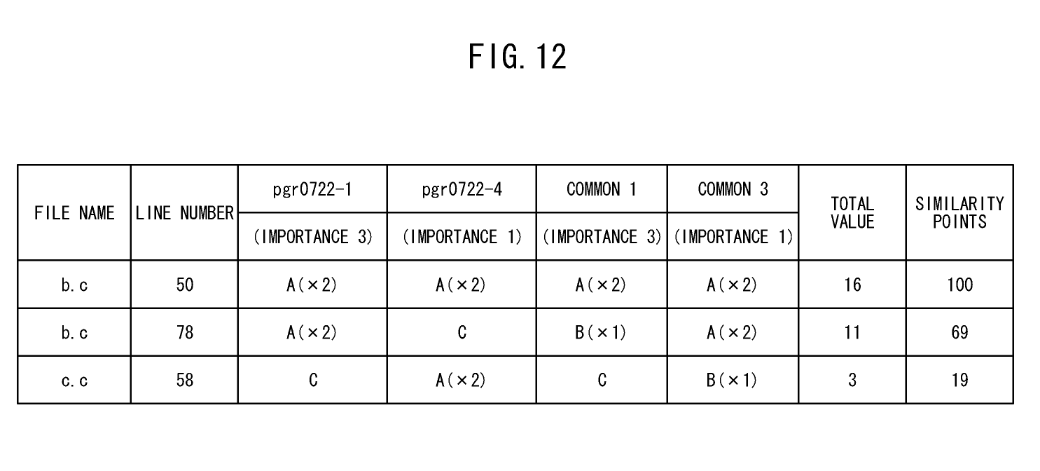

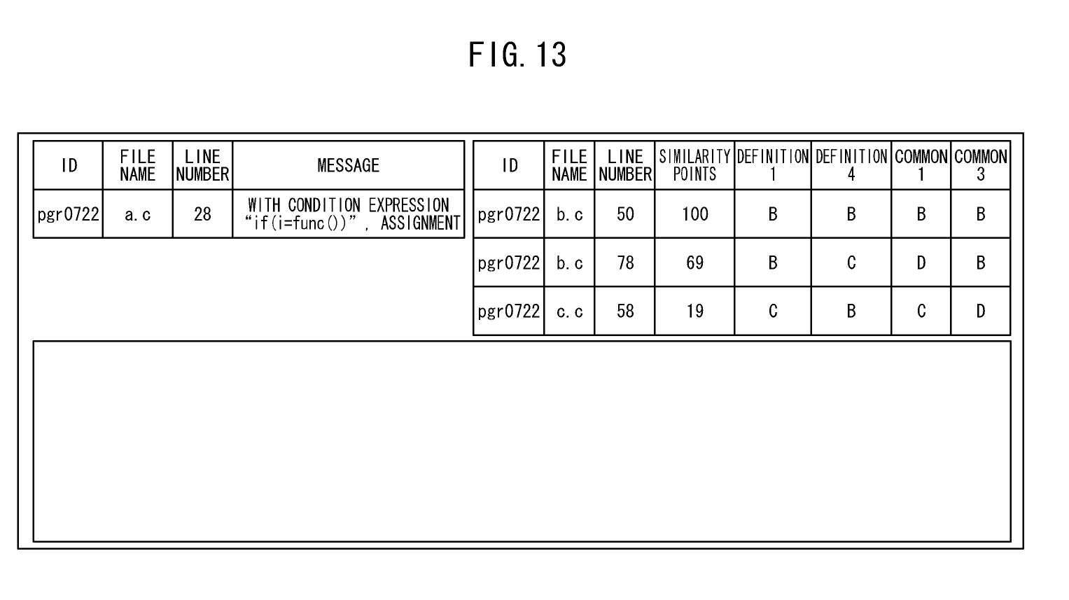

Firstly, using FIGS. 9 to 13, a description will be given of the configuration of the bug detection support apparatus according to the embodiment 2. FIG. 9 is a block diagram illustrating the configuration of the bug detection support apparatus according to the embodiment 2. FIG. 10 is a diagram illustrating one example of information stored in a calculation definition information storage unit. FIGS. 11 and 12 are diagrams for illustrating a process of the similarity calculation unit. FIG. 13 is a diagram illustrating one example of a similar structure identification information list.

The configuration of the bug detection support apparatus according to the embodiment 2, apart from further including a calculation definition information storage unit 27, as shown in FIG. 9, differs from the configuration of the bug detection support apparatus according to the embodiment 1 in the point to be described hereafter. That is, the calculation definition information storage unit 27 stores a plurality of items of calculation definition information indicating calculation definitions for calculating a similarity. To describe giving a specific example, the calculation definition information storage unit 27 correlates and stores calculation definition identification information, for identifying calculation definition information, with the calculation definition information, as shown in FIG. 10. Herein, for example, calculation definition identification information “pgr0722-1” means that the information is correlated to the detection condition identification information “pgr0722”. Also, for example, calculation definition identification information “Common-1” means that the information is correlated to all the items of detection condition identification information.

The similarity calculation unit 33 receives a selection of one item, or a plurality of items, of calculation definition information, from among the plurality of items of calculation definition information indicating calculation definitions for calculating a similarity, and importance information indicating an importance of each individual item of calculation definition information, from the software developer. Continuing, the similarity calculation unit 33, using each item of calculation definition information selected by the software developer, calculates a similarity corresponding to each item of calculation definition information for each item of structure identification information in the structure identification information list. Then, the similarity calculation unit 33, using the importance information, calculates a total value of values obtained by attaching an importance to each of the calculated similarities corresponding to each item of calculation definition information.

Specifically, the similarity calculation unit 33, on receiving a selection from the software developer of one item of structure identification information from the selected structure identification information list, via the input unit, retrieves the detection condition identification information correlated to the structure identification information selected by the software developer from the selection instruction information storage unit 25. Next, the similarity calculation unit 33 acquires, from among all the calculation definition information stored in the calculation definition information storage unit 27, the calculation definition information correlated to the detection condition identification information retrieved from the selection instruction information storage unit 25. Then, the similarity calculation unit 33 generates a dialog in which are listed the acquired items of calculation definition information, and outputs a display of the generated dialog for the software developer, via the output unit 12, as shown in FIG. 11.

Herein, the similarity calculation unit 33 receives an input of a selection of one item, or a plurality of items, of calculation definition information, from among the items of calculation definition information shown in the dialog, and of importance information indicating an importance of each individual item of calculation definition information. Continuing, the similarity calculation unit 33 retrieves, from among all the logs stored in the log storage unit 24, logs including detection condition identification information identical to the retrieved detection condition identification information, and acquires the structure identification information included in each retrieved log. Next, the similarity calculation unit 33, as well as extracting each structure which is to be a subject for comparison from among the analysis data stored in the analysis data storage unit 22, based on the acquired items of structure identification information, extracts a structure which is to be a basis for comparison, based on the structure identification information selected by the software developer.

Continuing, the similarity calculation unit 33, using each item of calculation definition information selected by the software developer, calculates a similarity corresponding to each item of calculation definition information for each item of structure identification information selected by the software developer. Then, the similarity calculation unit 33, using the importance information, calculates a total value of values obtained by attaching an importance to each of the calculated similarities corresponding to each item of calculation definition information, for each item of structure identification information.

For example, the similarity calculation unit 33 calculates a similarity “A” corresponding to the calculation definition identification information “pgr0722-1” for structure identification information (line number) “50” (refer to FIG. 12). Continuing, the similarity calculation unit 33 carries out an attaching of importance to the similarity corresponding to the calculation definition identification information “pgr0722-1” (refer to (x2) of FIG. 12). Then, the similarity calculation unit 33 calculates a similarity corresponding to each item of calculation definition identification information for the structure identification information “50”, until there are no more items of calculation definition identification information of which the similarity is to be calculated, and carries out an attaching of importance to each of the calculated similarities.

Herein, when there are no more items of calculation definition identification information of which the similarity is to be calculated, the similarity calculation unit 33 calculates a total value “16” of values obtained by attaching an importance to each of the similarities for the structure identification information “50”. Then, the similarity calculation unit 33 calculates a similarity corresponding to each item of calculation definition identification information for each item of structure identification information, until there are no more items of structure identification information for which the similarity is to be calculated, and calculates a total value of values obtained by attaching an importance to each of the calculated similarities.

The similarities corresponding to the items of calculation definition identification information “pgr0722-1” to “pgr0722-4” are calculated as a similarity “A” or a similarity “C”, depending on whether or not the structure which is the basis for comparison and the structure which is the subject for comparison both satisfy the calculation definition identification information. For example, the similarity corresponding to the calculation definition identification information “pgr0722-1” is a similarity “A” in the event that, in the structure which is the basis for comparison and the structure which is the subject for comparison, character strings on the right side of the assignment operator “=” match perfectly, and character strings on the left side of the assignment operator “=” match perfectly.

Also, the similarities corresponding to the items of calculation definition identification information “Common-1” to “Common-3”, calculating a concordance rate by a comparison of character strings between the structures, are calculated as a similarity “A” (a match of 80% or more), a similarity “B” (a match of 31% to 79%), or a similarity “C” (a match of 30% or less). Herein, the similarity “A” is converted to two points, the similarity “B” is converted to one point, and the similarity “C” is converted to one point. Also, the similarity points shown in FIG. 12 are values obtained by dividing the total value corresponding to each item of calculation definition identification information by a maximum total value (“16” in the example shown in FIG. 12).

The similar structure identification information list output unit 34 specifies items of structure identification information of which the total value of values obtained by attaching an importance to each of the similarities corresponding to each item of calculation definition information is of a pre-set predetermined threshold value or greater. Then, the similar structure identification information list output unit 34 generates a similar structure identification information list, in which are correlated and listed the specified items of structure identification information and the similarities corresponding to each item of calculation definition information, and outputs the generated similar structure identification information list, correlated to the structure identification information selected by the software developer. For example, the similar structure identification information list output unit 34 outputs the similar structure identification information list in the similarity viewer, as shown in FIG. 13.

### Process of Bug Detection Support Apparatus

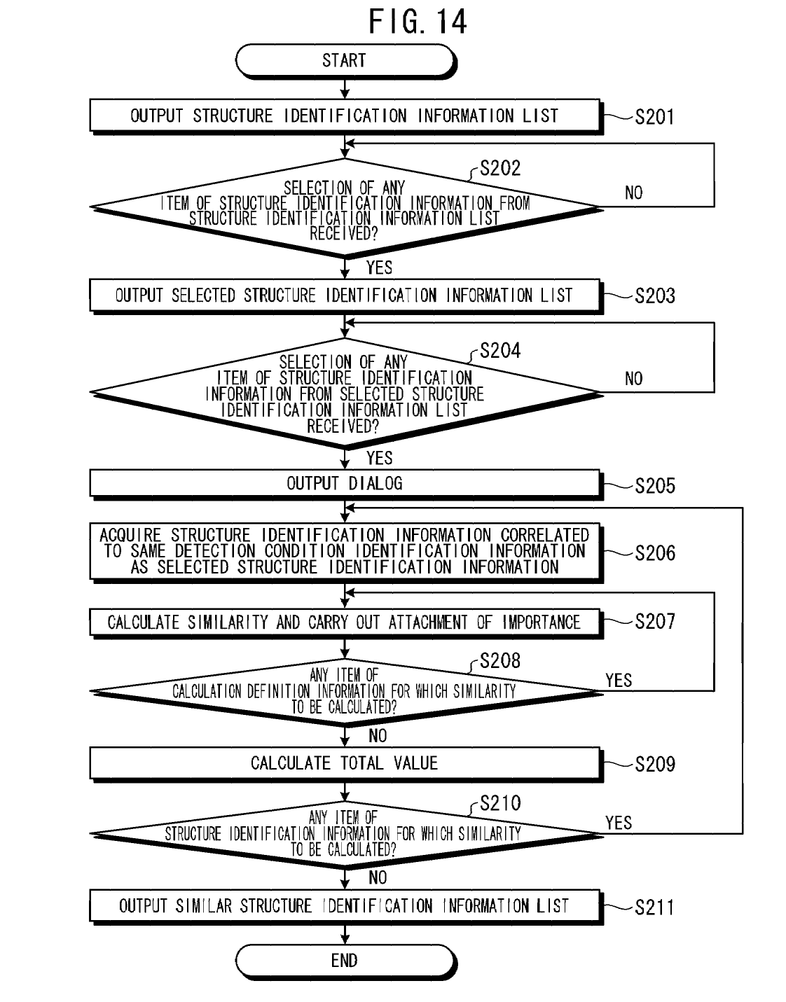

Next, a description will be given, using FIG. 14, of the process of the bug detection support apparatus 10. FIG. 14 is a flowchart illustrating the flow of the process of the bug detection support apparatus according to the embodiment 2. Hereafter, a description will be given only of points which differ from the process of the bug detection support apparatus according to the embodiment 1.

As shown in FIG. 14, the similarity calculation unit 33, on receiving a selection of one of the items of structure identification information from the selected structure identification information list (step S204: Yes), executes a calculation definition information setting process (step S205). Specifically, the similarity calculation unit 33 outputs a dialog in which are listed the items of calculation definition information correlated to the structure identification information selected by the software developer, and receives an input of a selection of calculation definition information and of importance information.

Then, the similarity calculation unit 33 acquires items of structure identification information correlated to the same detection condition identification information as the structure identification information selected by the software developer (step S206). Continuing, the similarity calculation unit 33 calculates the similarity corresponding to each item of calculation definition identification for the structure identification information selected by the software developer, and carries out an attachment of an importance to the calculated similarities (step S207).

Subsequently, when there are no more items of calculation definition identification information of which the similarity is to be calculated (step S208: No), the similarity calculation unit 33 calculates a total value of values obtained by attaching an importance to each of the calculated similarities (step S209). Continuing, the similarity calculation unit 33 acquires the structure identification information until there are no more items of structure identification information of which the similarity is to be calculated (S206), and repeatedly executes the heretofore described process. Then, when there are no more items of structure identification information of which the similarity is to be calculated (step S210: No), the similar structure identification information list output unit 34 generates and outputs a similar structure identification information list, in which are listed items of structure identification information of which the total value is of the pre-set predetermined threshold value or greater (step S211), and finishes the process.

### Advantages of Embodiment 2

As heretofore described, according to the embodiment 2, the bug detection support apparatus can output a similar structure identification information list generated in accordance with calculation definition information set by the software developer. For this reason, the software developer, being able to confirm whether or not a structure is a bug from a desired perspective, can effectively carry out a confirmation operation.

Also, according to the embodiment 2, the bug detection support apparatus can output a similar structure identification information list generated in accordance with calculation definition information to which the software developer attaches an importance. For this reason, the software developer, being able to confirm whether or not a structure is a bug from the same perspective, can even more effectively carry out a confirmation operation.

Also, according to the embodiment 2, the bug detection support apparatus can output a similar structure identification information list, in which are correlated and listed items of structure identification information and the similarities corresponding to each item of calculation definition information. For this reason, the software developer, being able to ascertain at a glance in what way each item of structure identification information in the similar structure identification information list is similar to selected structure identification information, can effectively carry out a bug confirmation operation.

### Embodiment 3

Thus far, a description has been given of the embodiments 1 and 2, but it is acceptable that the invention is embodied in various differing forms other than the heretofore described embodiments. Therein, a description will hereafter be given of another embodiment as an embodiment 3.

1. Saving Calculation Definition Information Importance History

For example, in the embodiment 2, a description is given of a case in which a dialog is output, asking the software developer for a selection of calculation definition information, and an attachment of an importance to the calculation definition information. However, by configuring in such a way that the bug detection support apparatus 10, when calculating the similarity, automatically retrieves the importance of each item of calculation definition information stored in advance in the storage unit, it is possible to eliminate time and effort of the software developer needed for an operation of inputting a selection of calculation definition information, and an attachment of an importance to the calculation definition information.

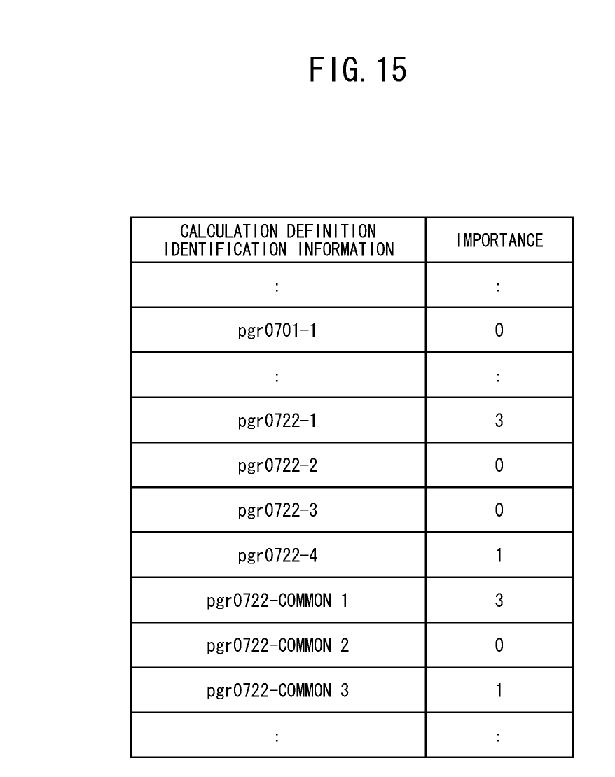

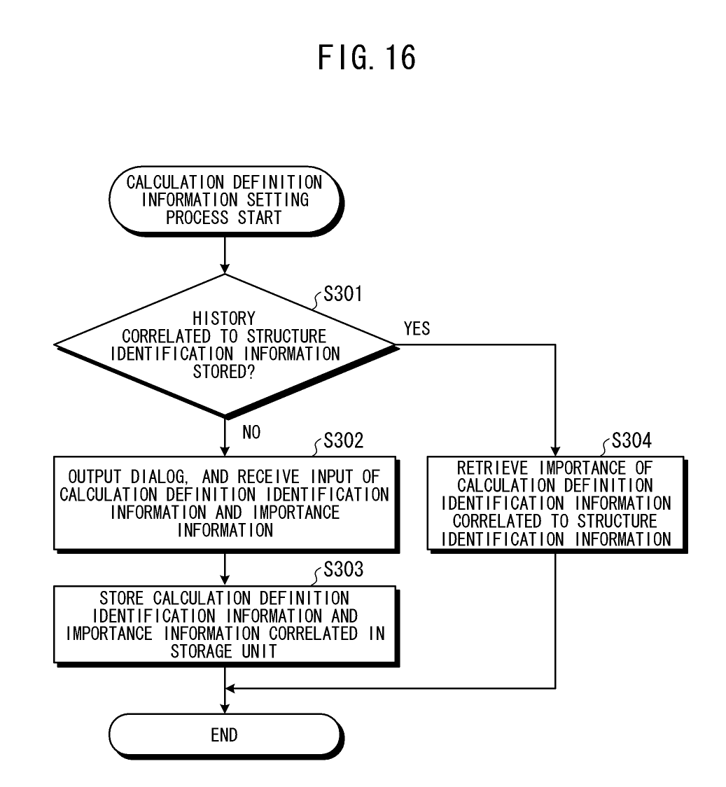

Specifically, the bug detection support apparatus 10 stores a history, in which are correlated calculation definition identification information and importance information indicating an importance of the calculation definition information, in the storage unit, as shown in FIG. 15. Then, as shown in FIG. 16, the similarity calculation unit 33, on receiving a selection of one of the items of structure identification information from the structure identification information list, determines whether or not an importance history of calculation definition identification information correlated to the structure identification information selected by the software developer is stored in the storage unit (step S301).

Herein, if no history is stored in the storage unit (step S301: No), the similarity calculation unit 33 outputs a dialog in which are listed items of calculation definition identification information, and receives an input of calculation definition identification information and importance information (step S302). Then, the similarity calculation unit 33 stores the received calculation definition identification information and importance information correlated in the storage unit (step S303), and finishes the calculation definition information setting process. Meanwhile, if a history is stored in the storage unit, the similarity calculation unit 33 retrieves the importance of the calculation definition identification information correlated to the structure identification information from the storage unit (step S304), and finishes the calculation definition information setting process. FIG. 15 is a diagram illustrating one example of a history. FIG. 16 is a flowchart illustrating the flow of the calculation definition information setting process.

2. Optional Setting of Concordance Rate and Points After Conversion

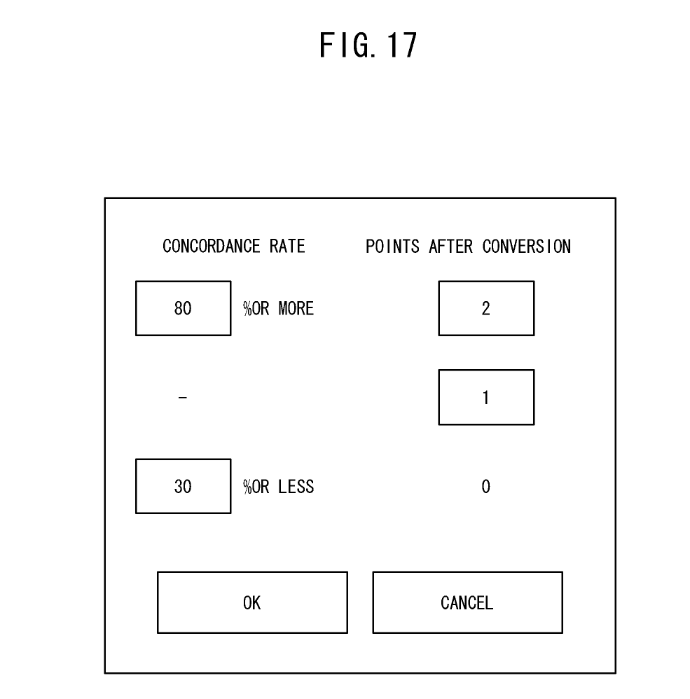

Also, in the embodiment 2, a description is given of a case in which a concordance rate derived from a comparison of character strings between structures is converted into points indicating a similarity, but it is also acceptable to configure in such a way that the kind of dialog shown in FIG. 17 is output, and the software developer can optionally set the concordance rate and the points after conversion. FIG. 17 is a diagram illustrating one example of a dialog for setting the concordance rate and the points after conversion.

3. Concordance Rate Calculation Method

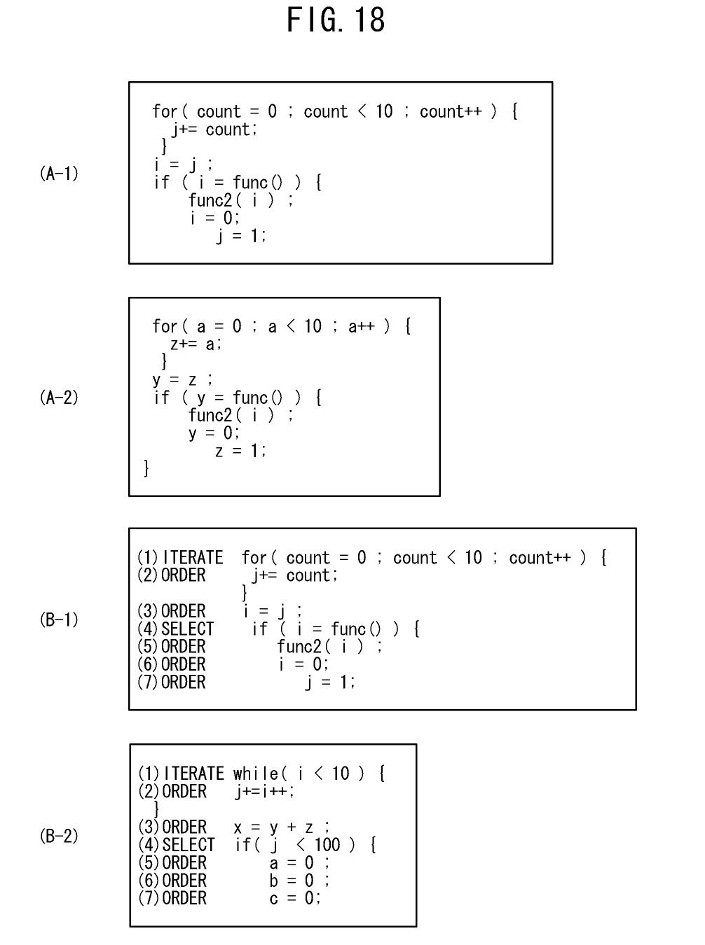

Also, in the embodiment 2, a description is given of a case in which the concordance rate is calculated by a comparison of character strings between structures, but it is also acceptable to take it that source descriptions match even in the event that identifier description methods differ, as shown in A-1 and A-2 of FIG. 18. It is also acceptable to conclude that source description structures match even in the event that details described in the structures differ, as shown in B-1 and B-2 of FIG. 18. FIG. 18 is a diagram for illustrating a concordance rate calculation method.

4. Apparatus Configuration and the Like

Also, it is possible, except where specifically mentioned, to optionally change information including the process procedures, control procedures, specific names, and various kinds of data and parameters shown in the above description and drawings (for example, the storage information shown in FIGS. 3, 4, 10 and 15, and the importance information shown in FIG. 15).

Also, each component of each apparatus shown in the drawings being a functionally conceptual one, it is not absolutely necessary that it is physically configured as shown. That is, a specific form of a dispersion or integration of each apparatus not being limited to that shown in the drawings, it is possible to configure functionally or physically dispersing or integrating a whole or one portion thereof in optional units, for example, to configure integrating the log storage unit 24 and selection instruction information storage unit 25 shown in FIG. 2, in accordance with various kinds of load, usage, or the like.

5. Bug Detection Support Programs

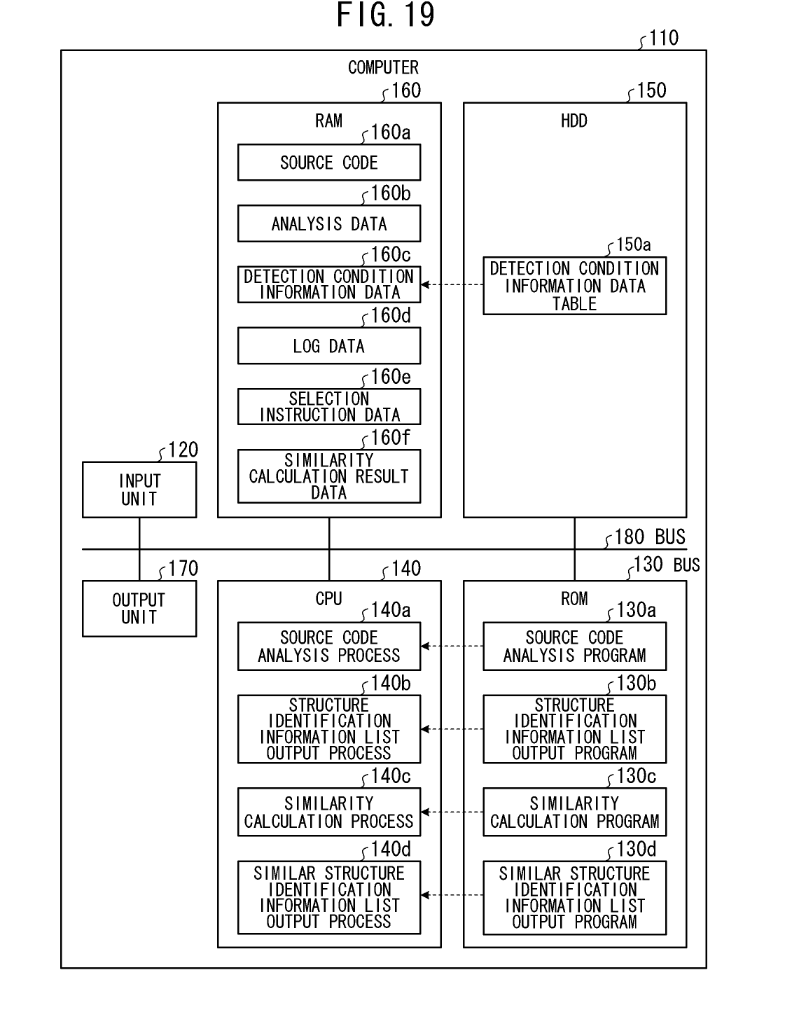

Meanwhile, it is also acceptable to configure in such a way that the invention is realized by a computer, acting as the bug detection support apparatus 10, executing programs prepared in advance. Therein, using FIG. 19, a description will hereafter be given, as one example, of a computer, including the same functions as the bug detection support apparatus 10 shown in the heretofore described embodiments, which executes bug detection support programs. FIG. 19 is a diagram illustrating the computer which executes the bug detection support programs.

As shown in FIG. 19, the computer 110, as the bug detection support apparatus 10, is configured connecting an input unit 120, an ROM 130, a CPU 140, an HDD 150, an RAM 160, and an output unit 170 with a bus 180, or the like.

The bug detection support programs, which fulfill the same functions as the bug detection support apparatus 10 shown in the heretofore described embodiment 1, that is, as shown in FIG. 19, a source code analysis program 130a, a structure identification information list output program 130b, a similarity calculation program 130c, and a similar structure identification information list output program 130d, are stored in advance in the ROM 130. In the same way as with the components of the bug detection support apparatus 10 shown in FIG. 2, it is acceptable to appropriately integrate or disperse the programs 130a to 130d.

Then, by the CPU 140 retrieving the programs 130a to 130d from the ROM 130 and executing them, the programs 130a to 130d function as a source code analysis process 140a, a structure identification information list output process 140b, a similarity calculation process 140c, and a similar structure identification information list output process 140d. The processes 140a to 140d correspond respectively to the source code analysis unit 31, structure identification information list output unit 32, similarity calculation unit 33, and similar structure identification information list output unit 34 shown in FIG. 2.

Also, a detection condition information data table 150a is provided in the HDD 150, as shown in FIG. 19. Then, the CPU 140 retrieves detection condition information data 160c from the detection condition information data table 150a, stores them in the RAM 160, and executes a process based on the detection condition information data 160c stored in the RAM 160, and on a source code 160a and selection instruction data 160e input via the input unit 120.

Data 160a to 160f correspond respectively to the source code storage unit 21, analysis data storage unit 22, detection condition information storage unit 23, log storage unit 24, selection instruction information storage unit 25, and similarity calculation result storage unit 26 shown in FIG. 2.

It not being absolutely necessary to store the heretofore described programs 130a to 130d in the ROM 130 from the outset, it is also acceptable to configure in such a way that the programs are stored on, for example, a “conveyable physical medium” inserted into the computer 110, such as a flexible disc (FD), CD-ROM, DVD, magneto optical disc, or IC card, or on a “fixed physical medium” installed inside or outside the computer 110, such as an HDD, or furthermore, in “another computer (or server)” connected to the computer 110 via a public line, internet, LAN, WAN, or the like, and the computer 110 retrieves the programs therefrom, and executes them.

6. Bug Detection Support Method

Also, the following kind of bug detection support method is realized by the heretofore described bug detection support apparatus. That is, a bug detection support method is realized which includes a structure identification information list output step (for example, step S103 of FIG. 8) of cross-referencing a source code configured of a plurality of structures, and a plurality of items of detection condition information indicating detection conditions for detecting a structure which is possibly a bug. Structures which are possibly a bug are detected, and a structure identification information list is generated listing structure identification information uniquely given to the detected structures, for a user. A similarity calculation step (for example, step S106 of FIG. 8), in the event of receiving from the user a selection of any item of structure identification information in the structure identification information list, calculates a similarity between structures corresponding to each item of structure identification information in the structure identification information list and a structure corresponding to the selected structure identification information. A structure identification information specification step specifies items of structure identification information, from among the items of structure identification information in the structure identification information list, of which the similarity calculated by the similarity calculation step is of a pre-set predetermined threshold value or greater, and a similar structure identification information list output step (for example, step S108 of FIG. 8) generates a similar structure identification information list, in which are listed the items of structure identification information specified by the structure identification information specification step. The generated similar structure identification information list, correlated to the structure identification information selected by the user, is output for the user.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A recording medium on which is recorded a bug detection support program, the bug detection support program causing a computer to execute:
a structure identification information list output step of cross-referencing a source code configured of a plurality of structures, and a plurality of items of detection condition information indicating detection conditions for detecting a structure which is possibly a bug, detecting structures which are possibly a bug, and outputting a structure identification information list, listing structure identification information uniquely given to the detected structures, for a user;
a similarity calculation step of, in the event of receiving from the user a selection of any item of structure identification information in the structure identification information list, calculating a similarity between structures corresponding to each item of structure identification information in the structure identification information list and a structure corresponding to the selected structure identification information;
a structure identification information specification step of specifying items of structure identification information, from among the items of structure identification information in the structure identification information list, of which the similarity calculated by the similarity calculation step is of a pre-set predetermined threshold value or greater; and
a similar structure identification information list output step of generating a similar structure identification information list, in which are listed the items of structure identification information specified by the structure identification information specification step, and outputting the generated similar structure identification information list, correlated to the structure identification information selected by the user, for the user.

2. The recording medium on which is recorded the bug detection support program according to claim 1, wherein
the structure identification information list output step generates a structure identification information list, in which are correlated and listed the items of structure identification information and items of detection condition information satisfied by structures corresponding to the items of structure identification information,
the similarity calculation step extracts from the structure identification information list items of structure identification information correlated to the same items of detection condition identification information as the structure identification information selected by the user, and calculates a similarity for each extracted item of structure identification information, and
the structure identification information specification step specifies items of structure identification information, from among the items of structure identification information correlated to the same items of detection condition identification information as the structure identification information selected by the user, of which the similarity calculated by the similarity calculation step is of a pre-set predetermined threshold value or greater.

3. The recording medium on which is recorded the bug detection support program according to claim 1, wherein
a bug detection support program recorded on the recording medium further causes a computer to execute:
a calculation definition information selection reception step of receiving from the user a selection of one item, or a plurality of items, of calculation definition information, from among the plurality of items of calculation definition information indicating the calculation definitions for calculating the similarity, wherein
the similarity calculation step calculates a similarity corresponding to each item of calculation definition information received by the calculation definition information selection reception step for each item of structure identification information in the structure identification information list, and
the structure identification information specification step specifies items of structure identification information of which a total value of the similarities corresponding to each item of calculation definition information calculated by the similarity calculation step is of a pre-set predetermined threshold value or greater.

4. The recording medium on which is recorded the bug detection support program according to claim 3, wherein
the bug detection support program recorded on the recording medium further causes a computer to execute:
an importance information reception step of receiving from the user importance information indicating an importance of each individual item of calculation definition information selected by the user, wherein
the structure identification information specification step, using the importance information received by the importance information reception step, specifies items of structure identification information of which a total value of values, obtained by attaching an importance to each of the similarities, calculated by the similarity calculation step, corresponding to each item of calculation definition information, is of a pre-set predetermined threshold value or greater.

5. The recording medium on which is recorded the bug detection support program according to claim 3, wherein
the similar structure identification information list output step generates a similar structure identification information list, in which are correlated and listed the items of structure identification information specified by the structure identification information specification step and the similarities, calculated by the similarity calculation step, corresponding to each item of calculation definition information, and outputs the generated similar structure identification information list, correlated to the structure identification information selected by the user, for the user.

6. A recording medium on which is recorded a similar structure identification information list output program, the similar structure identification information list output program causing a computer to execute:
a similarity calculation step of cross-referencing a source code configured of a plurality of structures, and, when receiving from a user a selection of any item of structure identification information from a structure identification information list in which the structure identification information for identifying structures which are possibly bugs is listed, calculating a similarity between structures corresponding to each item of structure identification information in the structure identification information list and a structure corresponding to the selected structure identification information;
a structure identification information specification step of specifying items of structure identification information, from among the items of structure identification information in the structure identification information list, of which the similarity calculated by the similarity calculation step is of a pre-set predetermined threshold value or greater; and
a similar structure identification information list output step of generating a similar structure identification information list, in which are listed the items of structure identification information specified by the structure identification information specification step, and outputting the generated similar structure identification information list, correlated to the structure identification information selected by the user, for the user.

7. A bug detection support apparatus, comprising:
a structure identification information list output unit which cross-references a source code configured of a plurality of structures, and a plurality of items of detection condition information indicating detection conditions for detecting a structure which is possibly a bug, detects structures which are possibly a bug, and outputs a structure identification information list, generated listing structure identification information uniquely given to the detected structures, for a user;
a similarity calculation unit which, in the event of receiving from the user a selection of any item of structure identification information in the structure identification information list, calculates a similarity between structures corresponding to each item of structure identification information in the structure identification information list and a structure corresponding to the selected structure identification information;
a structure identification information specification unit which specifies items of structure identification information, from among the items of structure identification information in the structure identification information list, of which the similarity calculated by the similarity calculation unit is of a pre-set predetermined threshold value or greater; and
a similar structure identification information list output unit which generates a similar structure identification information list, in which are listed the items of structure identification information specified by the structure identification information specification unit, and outputs the generated similar structure identification information list, correlated to the structure identification information selected by the user, for the user.

8. A bug detection support method comprising:
cross-referencing a source code configured of a plurality of structures, and a plurality of items of detection condition information indicating detection conditions for detecting a structure which is possibly a bug, detecting structures which are possibly a bug, and outputting a structure identification information list, generated listing structure identification information uniquely given to the detected structures, for a user;
in the event of receiving from the user a selection of any item of structure identification information in the structure identification information list, calculating a similarity between structures corresponding to each item of structure identification information in the structure identification information list and a structure corresponding to the selected structure identification information;
specifying items of structure identification information, from among the items of structure identification information in the structure identification information list, of which the calculated similarity is of a pre-set predetermined threshold value or greater; and
generating a similar structure identification information list, in which are listed the items of structure identification information specified, and outputting the generated similar structure identification information list, correlated to the structure identification information selected by the user, for the user.
